(19) United States
(12) Patent Application Publication
(10) Pub. No.: US 2008/0232438 A1
(43) Pub. Date: Sep. 25, 2008

(54) 2D Rake Receiver For Use in Wireless Communication Systems

(75) Inventors: Yanzhong Dai, Shanghai (CN); Luzhou Xu, Shanghai (CN); Yan Li, Shanghai (CN)

Correspondence Address: PHILIPS INTELLECTUAL PROPERTY & STANDARDS, PO BOX 3001, BRIARCLIFF MANOR, NY, 10510-8001, US

(73) Assignee: Koninklijke Philips Electronics N. V.

(21) Appl. No.: 10/581,807

(22) PCT Filed: Nov. 19, 2004
(86) PCT No.: PCT/IB04/52487

§ 371 Date: Jun. 2, 2006

(30) Foreign Application Priority Data
Dec. 5, 2003 (CN) 200310122521.6

(51) Int. Cl. H04B 1/707; H04B 1/10; H04B 7/08

(52) U.S. Cl. 375/148; 375/347; 455/132; 375/E01.032

(57) ABSTRACT

A 2D Rake receiver is proposed, comprising: a control module, for generating, according to a reference signal and the radio signals received by a plurality of antenna elements, the multipath information about the radio signals; a weight factor calculating unit, for calculating the corresponding weight factors of the received radio signals corresponding to different antenna elements according to the multipath information; a plurality of 1 D Rake receivers, each of which is for receiving radio signals from the corresponding antenna element and weighting the radio signals received by the Rake receiver with the corresponding weight factor; a combining unit, for combing the weighted radio signals outputted from the plurality of 1 D Rake receivers, to output a combined signal.

### FIELD OF THE INVENTION

The present invention relates generally to a receiver for use in wireless communication systems, and more particularly, to a 2D Rake receiver for use in wireless communication systems.

### BACKGROUND ART OF THE INVENTION

In wireless communication, due to the reflection and diffraction of barriers in the propagation channel, a signal from the source will arrive at the destination via multiple paths, in multiple directions and with different delays. So, the signal received by the destination terminal is composed of multipath signals from different paths, and thus the so-called multipath effect is introduced, which often results in drastic deterioration of channel conditions and degradation in system performance. Many reception techniques are put forward to alleviate the impact of multipath effect on the system performance. These reception techniques can be classified into two types: one is Rake receiver technique in which multipath signals are processed in time diversity; the other is smart antenna technique in which multipath signals are processed in space diversity.

Rake receiver is a technique for alleviating the impact of multipath effect on the system performance in 2G wireless communication systems. It utilizes the time characteristic that different multipath signals arrive at the antenna with different delays, to combine these multipath signals in time diversity to achieve time diversity gain. FIG. 1 displays a typical structure of Rake receiver. As FIG. 1 shows, Rake receiver first uses MF 1, 2, 3, . . . in MF (Match Filter) unit 100 to match a multipath signal with specified delay in the input signal respectively; then combination control unit 120 calculates the weight factor of each multipath signal according to the multipath signals outputted from MF 1, 2, 3, . . . and the reference signal (such as SYNC_DL and mid amble in TD-SCDMA, the pilot information and spreading codes in CDMA IS95 , CDMA2000 and WCDMA); afterwards, weighting unit 130 multiplies the multipath signals outputted from MF 1, 2, 3, . . . by the corresponding calculated weight factors; lastly, combining unit 140 combines each weighted multipath signal outputted from weighting unit 130 to get the output signal.

Smart antenna is a technique for alleviating the impact of multipath effect on the system performance in 3G wireless communication systems. It utilizes the space characteristic that different multipath signals arrive at the antenna array with different DOAs (Direction Of Arrival), to combine these multipath signals into one signal to achieve space diversity gain. FIG. 2 displays a typical structure of smart antenna. As FIG. 2 shows, smart antenna receives two input signals 1 and 2 through two antenna elements (not given in the figure) first; then combination control unit 150 calculates the weight factors of input signal 1 and input signal 2 according to the reference signal (such as SYNC_DL and mid amble in TD-SCDMA, the pilot information and spreading codes in CDMA IS95 , CDMA2000 and WCDMA) and the feedback signal (i.e. the output of the smart antenna); afterwards, weighting unit 160 multiplies input signal 1 and input signal 2 by the corresponding weight factors calculated by combination control unit 150; lastly, combining unit 170 combines the weighted input signal 1 and input signal 2 outputted from weighting unit 160 to get the output signal, and feeds it back to combination control unit 150 as the feedback signal.

Utilization of the above Rake receiver and smart antenna can alleviate the impact of multipath signals on system performance to a certain extent, but the result is not ideal enough. To further improve SINR (Signal-to-Interference-Noise Ratio) and decrease BER (Bit-Error-Rate), or decrease power consumption to obtain the same system performance, a 2D Rake receiver is put forward. The 2D Rake receiver utilizes the techniques of Rake receiver and smart antenna, but is more than a simple combination of Rake receiver and smart antenna. The system performance of 2D Rake receiver is better than one-dimensional processing method (smart antenna or Rake receiver), or one after another (with smart antenna processing first and then Rake receiver processing, or Rake receiver processing first and then smart antenna processing).

FIG. 3 shows the structure of an existing 2D Rake receiver. As shown in FIG. 3, first, antenna array 180 receives N signals by using N antenna elements. Then, DOA estimating unit 190 estimates the DOA of each propagation path according to the N signals received by antenna array 180, and multipath searching unit 200 finds K propagation paths with the strongest power from the propagation paths, with their DOAs arranged as ω1, ω2, . . . , ωK in power decremental order. Afterwards, beam forming units BF1, . . . , BFK in beam forming unit group 210 combine the multipath signals from the propagation paths with DOAs as ω1, ω2, . . . , ωK respectively, according to the N signals received by antenna array 180. And next, Rake fingers RF1, . . . , RFK in Rake receiver 140 weight the outputs of BF1, . . . , BFK in beam forming unit group 220 respectively. Lastly, combining unit 230 combines the signals outputted from each Rake finger in Rake receiver 220, to get the user signal.

The above description to conventional 2D Rake receiver indicates that multiple beam forming units are first needed for space-domain processing and Rake receiver is then used for signal processing in time-domain, to get the user signal. So this structure is relatively complicated and the processing method is not flexible enough.

### SUMMARY OF THE INVENTION

To overcome the shortcomings of complicated structure and inflexible processing method in existing 2D Rake receiver and further improve the system performance, a new 2D Rake receiver is proposed in the present invention for use in wireless communication systems.

An object of the present invention is to provide a 2D Rake receiver for use in wireless communication systems. The 2D Rake receiver performs joint time-space processing on the input signals received by the antenna array, without using beam forming units for space-domain processing any more. Compared with existing 2D Rake receiver, the proposed new 2D Rake receiver has more simple structure and more flexible processing method, and can achieve better system performance.

A 2D Rake receiver in accordance with the present invention, comprises: a control module, for generating, according to a reference signal and the radio signals received by a plurality of antenna elements, multipath information about the radio signals; a weight factor calculating unit, for calculating, according to the multipath information, the corresponding weight factors of the received radio signals corresponding to different antenna elements; a plurality of 1D Rake receivers, each of which is for receiving radio signals from the corresponding antenna element and weighting its received radio signals with the corresponding weight factor; a combining unit, for combing the weighted radio signals outputted from the plurality of 1D Rake receivers, to output a combined signal.

### BRIEF DESCRIPTION OF THE DRAWINGS

FIG. 1 is a block diagram illustrating the typical structure of conventional Rake receiver;

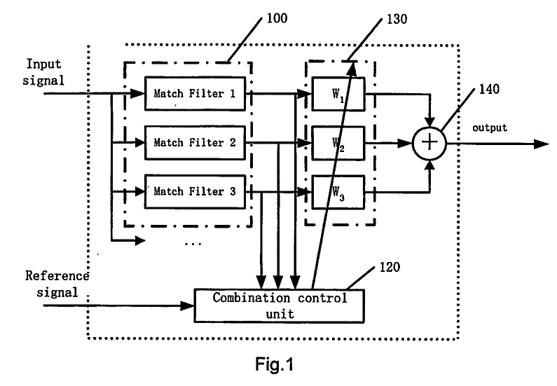

FIG. 2 is a block diagram illustrating the typical structure of conventional smart antenna;

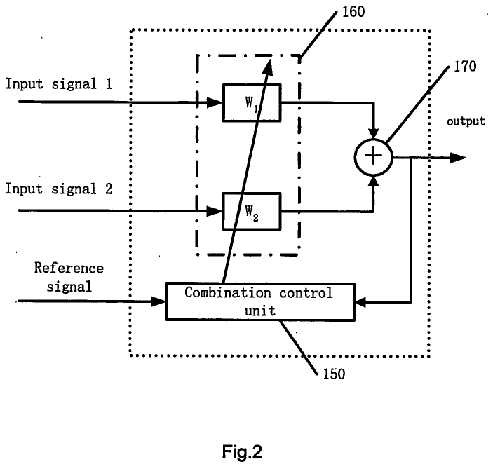

FIG. 3 is a block diagram illustrating the structure of conventional 2D Rake receiver;

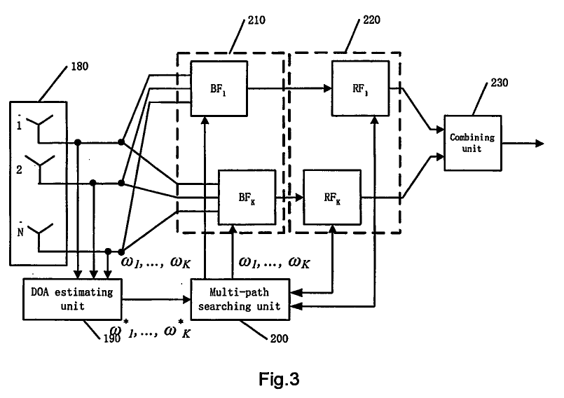

FIG. 4 is a block diagram illustrating the structure of the 2D Rake receiver in an embodiment of the present invention;

FIG. 5 illustrates the principle of calculating the weight factors for multipath signals in an embodiment of the present invention;

FIG. 6 illustrates the proposed 2D Rake receiver for use in TD-SCDMA wireless terminals in an embodiment of the present invention.

### DETAILED DESCRIPTION OF THE INVENTION

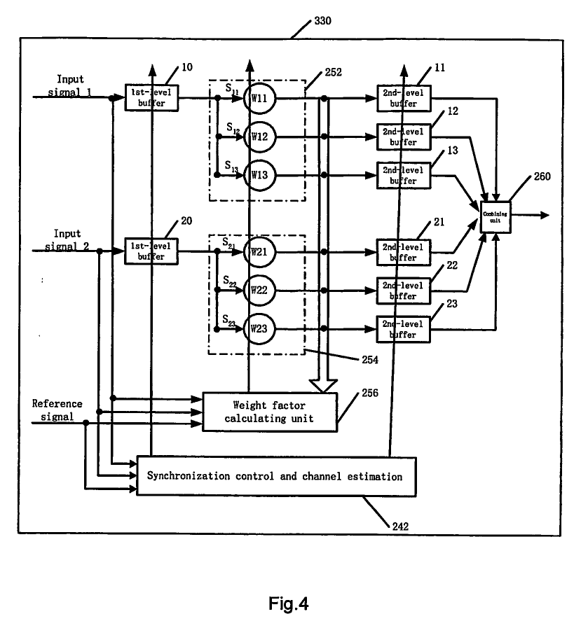

FIG. 4 is a block diagram illustrating the 2D Rake receiver for use in wireless communication systems in an embodiment of the present invention. The 2D Rake receiver can be applied in TD-SCDMA, WCDMA, CDMA IS95 and CDMA2000 . For simplicity of description, the 2D Rake receiver offers a situation of processing only two input signals. The principle of processing more than two input signals is the same.

A detailed description is given below to the proposed 2D Rake receiver to be used in mobile terminals, in conjunction with FIG. 4.

1. Caching the Input Signals from the Antenna Array

The first-level buffers 10 and 20 in 2D Rake receiver 330 of the mobile terminal respectively receive and cache input signal 1 and input signal 2 from different elements in the antenna array (not shown in the figure).

2. Synchronization Processing and Channel Estimation

In 2D Rake receiver 330, synchronization control and channel estimation unit 242 generates synchronization control information according to the reference signal (such as SYNC_DL and mid amble in TD-SCDMA, pilot information and spreading codes in CDMA IS95 , CDMA2000 and WCDMA) and input signal 1 and input signal 2, and provides the synchronization control information to the first-level buffers 10 and 20 and the second-level buffers 11, 12, 13 and 21, 22, 23.

After synchronizing input signal 1 and input signal 2 by using the synchronization control information, synchronization control and channel estimation unit 242 also detects the multipath information included in the synchronized input signal 1 and input signal 2 according to the supplied reference signal, and provides the multipath information to weight factor calculating unit 256 and Rake receivers 252 and 254, wherein the multipath information is concerned with the multipath number, multipath delay information and the estimated amplitude of each propagation path (the estimated impact of different propagation paths on the amplitude of the transmitted radio signal).

3. Separating Each Multipath Component of the Signal

In 2D Rake receiver 330, by utilizing the synchronization control information from synchronization control and channel estimation unit 242, the first-level buffers 10 and 20 adjust the synchronization of input signal 1 and input signal 2, and output the synchronized input signal 1 and input signal 2 to Rake receiver 252 and Rake receiver 254.

Rake receiver 252 and Rake receiver 254 are both one-dimensional. After receiving input signal 1 and input signal 2 synchronized by the first-level buffers 10 and 20, Rake receiver 252 forwards the multipath signals included in input signal I into Rake fingers S11, S12, S13 according to the multipath number and multipath delay information included in the multipath information from synchronization control and channel estimation unit 242. Wherein the number of Rake fingers corresponds to the multipath number. In the embodiment of the present invention, it's supposed that the signals received by the Rake receiver are delivered through three paths. Similarly, Rake receiver 254 forwards the multipath signals included in input signal 2 to S21, S22, S23.

4. Calculating the 2D Time-Space Weight Factor Corresponding to Each Rake Finger

In 2D Rake receiver 330, weight factor calculating unit 256 adopts relevant algorithms to calculate the 2D time-space weight factor corresponding to each multipath signal included in input signal 1 and input signal 2, according to the multipath information supplied by synchronization control and channel estimation unit 242, and provides the calculated 2D weight factors to each corresponding Rake finger.

When the 2D weight factors are calculated, two methods can be adopted.

In the first method, weight factor calculating unit 256 calculates the preliminary weight factor of each Rake finger based on the reference signal. That is, the preliminary weight factor of each Rake finger corresponding the propag ation path can be calculated with algorithms based on MMSE rule for instance, by using signals received by different antenna elements from the same propagation path and according to the multipath delay information supplied by synchronization control and channel estimation unit 242. Then, the 2D time-space weight factor of each Rake finger corresponding to the propagation path can be obtained by multiplying the preliminary weight factor of each Rake finger corresponding the propagation path with the estimated amplitude of the path, according to the estimated amplitude of each path supplied by synchronization control and channel estimation unit 242.

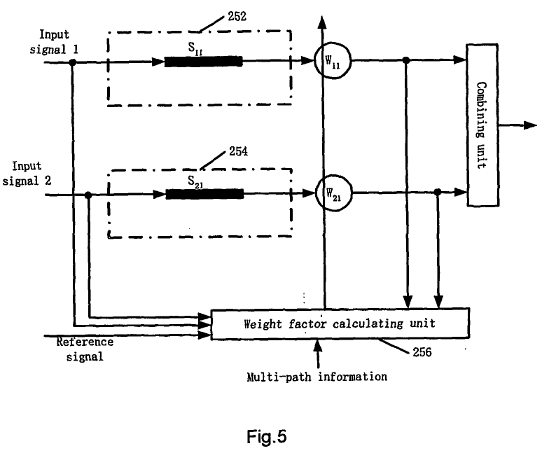

The following section will describe the first method for calculating the 2D time-space weight factor in accordance with an embodiment of the present invention, in conjunction with FIG. 5. For clarification of description, only two Rake fingers S11 and S21 are exemplified to present the operation procedure for calculating weight factors and performing weighted combination with weight factors, and other Rake fingers employ similar operation procedure for calculating weight factors and performing weighted combination with weight factors. In the embodiment, it's assumed that the multipath signals received by S11 and S21 are from the same propagation path. Wight factor calculating unit 256 can calculate the preliminary factors of S11 and S21 based on MMSE rule, according to the multipath delay information provided by synchronization control and channel estimation unit 242. Then, weight factor calculating unit 256 multiplies the preliminary factors of S11 and S21 by the estimated amplitude of the corresponding propagation path provided by synchronization control and channel estimation unit 242, to get the corresponding 2D time-space weight factors W11 and W21 of Rake fingers S11 and S21.

Similarly, weight factor calculating unit 256 can respectively calculate the 2D time-space weight factors W12, W13, W22 and W23 of other Rake fingers S12, S13, S22 and S23, based on the reference signal and according to the multipath delay information and the estimated amplitude of each path provided by synchronization control and channel estimation unit 242.

In the second method, weight factor calculating unit 256 first calculates the preliminary weight factor of each Rake finger by using the output signal of each Rake finger as the feedback signal, instead of the reference signal. That is, the preliminary weight factor of each Rake finger corresponding the propagation path can be calculated with algorithms such as blind adaptive algorithm, based on signals received by different antenna elements from the same propagation path and according to the multipath delay information provided by synchronization control and channel estimation unit 242. Then, the 2D time-space weight factor of each Rake finger corresponding to the propagation path can be obtained by multiplying the preliminary weight factor of each Rake finger corresponding the propagation path with the estimated amplitude of the path, according to the estimated amplitude of each path provided by synchronization control and channel estimation unit 242.

Still referring to FIG. 5, it's assumed that the multipath signals received by Rake fingers S11 and S21 are from the same propagation path. Weight factor calculating unit 256 can calculate the preliminary weight factors of S11 and S21 based on blind adaptive algorithm, according to the multipath delay information provided by synchronization control and channel estimation unit 242. Then, weight factor calculating unit 256 multiplies the preliminary factors of S11 and S21 by the estimated amplitude of the corresponding propagation path provided by synchronization control and channel estimation unit 242, to get the corresponding 2D time-space weight factors W11 and W21 of Rake fingers S11 and S21.

Similarly, weight factor calculating unit 256 can calculate the 2D time-space weight factors W12, W13, W22 and W23 of other Rake fingers S12, S13, S22 and S23 respectively, according to the multipath delay information and the estimated amplitude of each path provided by synchronization control and channel estimation unit 242.

5. Weighting the Multipath Signals

Rake fingers S11, S12 and S13 in Rake receiver 252 respectively multiply to their received multipath signals by the corresponding 2D time-space weight factors W11, W12 and W13 calculated by weight factor calculating unit 256, and forward each weighted multipath signal to the second-level buffers 11, 12 and 13 in 2D Rake receiver 330 respectively (the number of the second-level buffers should correspond to the number of Rake fingers in Rake receiver 252). Similarly, Rake fingers S21, S22 and S23 in Rake receiver 254 respectively multiply their received multipath signals by the corresponding 2D time-space weight factors W21, W22 and W23 calculated by weight factor calculating unit 256, and send each weighted multipath signal to the second-level buffers 21, 22 and 23 in 2D Rake receiver 330.

### 6. Aligning the Time Delay of Each Weighted Multipath Signal

After the second-level buffers 11, 12, 13 and 21, 22, 23 in 2D Rake receiver 330 receive the multipath signal outputted from Rake receivers 252 and 254 respectively, they adjust the time delay of the received multipath signals according to the synchronization control information and multipath information sent by synchronization control and channel estimation unit 242, so that these multipath signals can be time aligned.

7. Combining

Combining unit 260 combines the time-aligned multipath signals outputted from the second buffers 11, 12, 13 and 21, 22, 23, to get the output signal.

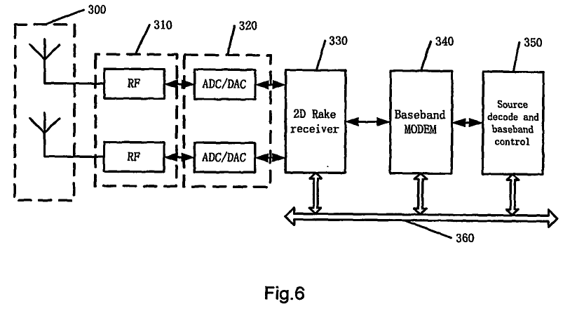

FIG. 6 displays an embodiment of the proposed 2D Rake receiver used in TD-SCDMA wireless terminals. A detailed description will be given below to the embodiment, in conjunction with FIG. 6.

After the wireless terminal powers on, baseband MODEM unit 340 finds the cell's SYNC_DL (downlink synchronization code) in DwPTS in each sub-frame by using MF during cell search procedure. When the wireless terminal is establishing communication with the base station, baseband MODEM unit 340 acquires the mid amble allocated by the base station for the wireless terminal. Then, baseband MODEM unit 340 sends the acquired SYNC_DL and the mid amble allocated for the wireless terminal to 2D Rake receiver 330 through data bus 360, to provide it to 2D Rake receiver 330 as the reference signal.

When the base station is communicating with the wireless terminal, 2D Rake receiver 330 in the wireless terminal receives input signal 1 and input signal 2 containing the user signal, and caches them in the first buffers in 2D Rake receiver 330 respectively. Input signal 1 and input signal 2 are from different elements of antenna array 300, and have been processed by RF processing unit 310 and AD/DA processing unit 320.

After receiving the input signals, the synchronization control and channel estimation unit in 2D Rake receiver 330 generates the synchronization control and multipath information in the way of the above-mentioned synchronization processing and channel estimation, according to the SYNC_DL and the mid amble allocated to the wireless terminal from baseband MODEM unit 340. According to the aforementioned method, 2D Rake receiver 330 performs steps of: separating each multipath signal, calculating the 2D time-space weight factor of each Rake finger for the multipath signal, weighting the multipath signal of each Rake finger, time aligning the, weighted multipath signal of each Rake finger and combining the time aligned multipath signal of each Rake finger.

Baseband MODEM unit 340 performs channel decoding on the user signal from 2D Rake receiver 330 by using JD (joint detection), Viterbi decoding or Turbo decoding techniques, and sends the decoded signal to source decode and baseband control unit 350.

Source decode and baseband control unit 350 performs source decoding on the channel-decoded signal from baseband MODEM unit 340, and carries out further relevant processing on the source-decoded user signal.

In can be seen from FIG. 6 that the proposed 2D Rake receiver can reuse almost all software modules of existing systems, such as the spreading/despreading module, MODEM module, Viterbi/Turbo decoding module and so on. Moreover, the interface of the 2D Rake receiver is compatible with that of existing standard baseband MODEM unit, so the standard baseband MODEM unit can be reused, and the 2D Rake receiver and the baseband MODEM unit can transfer information about the SYNC_DL and mid amble through the data bus.

### Beneficial Results of the Invention

As described above, in the proposed 2D Rake receiver for use in wireless communication systems, multiple Rake receivers are used to weight the input signals received by different elements in the antenna array directly. Therefore, compared with existing 2D Rake receiver, beam forming units are no longer needed for processing each multipath signal, thus the proposed 2D Rake receiver has more simple structure and more flexible processing method, and can achieve better system performance.

Furthermore, the proposed 2D Rake receiver can reuse almost all software and hardware modules of existing systems, which brings fewer modifications to existing systems and lowers relevant application cost.

It is to be understood by those skilled in the art that the proposed 2D Rake receiver for use in wireless communication systems as described herein can be applied to TD-SCDMA, WCDMA, CDMA IS95 and CDMA2000 , and equally extends to chipsets and components, mobile wireless communication terminals and WLAN terminals and etc.

The foregoing description of the preferred embodiment is provided to enable any person skilled in the art to make or use the present invention. Various modifications to the embodiment will be readily apparent to those skilled in the art, and the generic principles defined herein may be applied to other embodiments without the use of the inventive faculty. Thus, the present invention is not intended to be limited to the embodiment shown herein but is to be accorded the widest scope consistent with the principles and novel features disclosed herein.

1. A 2D Rake receiver, comprising:
a control module, for generating, according to a reference signal and the radio signals received by a plurality of antenna elements, multipath information about the radio signals;
a weight factor calculating unit, for calculating the corresponding weight factors of the received radio signals corresponding to different antenna elements, according to the multipath information;
a plurality of ID Rake receivers, each of which is for receiving radio signals from the corresponding antenna element and weighting the radio signals received by the Rake receiver with the corresponding weight factor;
a combining unit, for combing the weighted radio signals outputted from the plurality of ID Rake receivers, to output a combined signal.

2. The 2D Rake receiver according to claim 1, wherein every said 1D Rake receiver includes a plurality of Rake fingers, each of which corresponds to the corresponding propagation path and weights its received radio signals with the corresponding weight factor.

3. The 2D Rake receiver according to claim 2, wherein said multipath information at least includes multipath delay information and multipath amplitude estimation information.

4. The 2D Rake receiver according to claim 3, wherein said weight factor calculating unit calculates the input signals of the corresponding Rake finger in said plurality of 1D Rake receivers according to said reference signal and said multipath information, and calculates said corresponding weight factor of the corresponding Rake finger according to the calculation result and the estimated amplitude of the corresponding Rake finger, wherein the corresponding Rake finger is the Rake finger for receiving radio signals transferred from the same propagation path in said plurality of 1D Rake receivers.

5. The 2D Rake receiver according to claim 4, wherein said weight factor calculating unit calculates the input signals of said corresponding Rake finger by adopting algorithms based on MMSE (Minimum Mean-Squared Error) rule.

6. The 2D Rake receiver according to claim 3, wherein said weight factor calculating unit calculates the input signals of the corresponding Rake finger according to said multipath information and the output signals of the corresponding Rake finger in said plurality of 1D Rake receiver, and calculates said corresponding weight factor of the corresponding Rake finger according to the calculation result and the estimated amplitude of the corresponding Rake finger, wherein said corresponding Rake finger is the Rake finger for receiving radio signals transferred from the same propagation path in said plurality of 1D Rake receivers.

7. The 2D Rake receiver according to claim 6, wherein said weight factor calculating unit calculates the input signals of said corresponding Rake finger with blind adaptive algorithm.

8. The 2D Rake receiver according to claim 1, wherein said control module generates synchronization control information according to said reference signal and the radio signals received by said plurality of antenna elements, the 2D Rake receiver further comprising:
a plurality of first-level buffers, for synchronizing the radio signals received by said plurality of antenna elements according to the synchronization control information, so that the radio signals inputted into said plurality of 1D receivers can maintain synchronization.

9. The 2D Rake receiver according to claim 8, wherein said reference signal is downlink synchronization code and mid amble code.

10. The 2D Rake receiver according to claim 8, wherein said reference signal is pilot information and spreading code.

11. A method for 2D Rake processing the received radio signals, comprising steps of:
(a) generating, according to a reference signal and the radio signals received by a plurality of antenna elements, the multipath information about the radio signals;
(b) calculating the corresponding weight factor of the received radio signals corresponding to the plurality of antenna elements according to the multipath information;
(c) weighting the radio signals received by a plurality of Rake fingers from the plurality of antenna elements, according to the corresponding weight factor;
(d) combining the weighted radio signals outputted from the plurality of Rake fingers to output a combined signal.

12. The method according to claim 11, wherein said multipath information at least includes multipath delay information and multipath amplitude estimation information.

13. The method according to claim 12, wherein step (b) includes:
(b1) calculating the input signals of the corresponding Rake finger in said plurality of Rake fingers according to said reference signal and said multipath information, wherein the corresponding Rake finger is the Rake finger for receiving radio signals transferred from the same propagation path;
(b2) calculating said corresponding weight factor of the corresponding Rake finger according to the calculation result and the estimated amplitude of the corresponding Rake finger.

14. The method according to claim 13, wherein algorithms based on MMSE rule are adopted to calculate the input signals of said corresponding Rake fingers.

15. The method according to claim 12, wherein step (b) includes:
(b1) calculating the input signals of the corresponding Rake finger according to said multipath information and the output signals of the corresponding Rake finger in said plurality of Rake fingers, wherein the corresponding Rake finger is the Rake finger for receiving radio signals transferred from the same propagation path;
(b2) calculating said corresponding weight factor of the corresponding Rake finger according to the calculation result and the estimated amplitude of the corresponding Rake finger.

16. The method according to claim 15, wherein the input signals of said corresponding Rake finger are calculated with blind adaptive algorithm.

17. The method according to claim 11 further comprising steps of:
generating synchronization control information according to said reference signal and the radio signals received by said plurality of antenna elements;
synchronizing respectively the radio signals received by said plurality of antenna elements according to the synchronization control information, so that the radio signals inputted into said plurality of Rake fingers can maintain synchronization.

18. The method according to claim 17, wherein said reference signal is downlink synchronization code and mid amble code.

19. The method according to claim 17, wherein said reference signal is pilot information and spreading code.

20. A mobile terminal, comprising:
a plurality of antenna elements, each of which is for receiving and transmitting radio signals;
a 2D Rake receiver, for receiving radio signals from the plurality of antenna elements, and weighting and combining the radio signals received by the plurality of antenna elements into an output signal;
a baseband MODEM unit, for baseband demodulating the output signals of the 2D Rake receiver, and baseband modulating the signals to be transmitted and then transmitting them via the antenna elements.

21. The mobile terminal according to claim 20, wherein said 2D Rake receiver includes:
a control module, for generating, according to a reference signal and the radio signals received by said plurality of antenna elements, multipath information about the radio signals;
a weight factor calculating unit, for calculating the corresponding weight factor of the received radio signals corresponding to different antenna elements;
a plurality of 1D Rake receiver, each of which is for receiving radio signals from the corresponding antenna elements and weighting the radio signals received by said Rake receiver with the corresponding weight factor;
a combining unit, for combing the weighted radio signals outputted by the plurality of 1D Rake receivers, to output a combined signal.

22. The mobile terminal according to claim 21, wherein said multipath information at least includes multipath delay information and multipath amplitude estimation information.

23. The mobile terminal according to claim 22, wherein said weight factor calculating unit calculates the input signals of the corresponding Rake finger in said plurality of 1D Rake receivers according to said reference signal and said multipath information, and calculates said corresponding weight factor of the corresponding Rake finger according to the calculation result and the estimated amplitude of the corresponding Rake finger, wherein the corresponding Rake finger is the Rake finger for receiving radio signals transferred from the same propagation path in said plurality of 1D Rake receivers.

24. The mobile terminal according to claim 23, wherein said weight factor calculating unit calculates the input signals of said corresponding Rake finger with algorithms based on MMSE rule.

25. The mobile terminal according to claim 22, wherein said weight factor calculating unit calculates the input signals of the corresponding Rake finger according to said multipath information and the output signals of the corresponding Rake finger in said plurality of 1D Rake receivers, and calculates said corresponding weight factor of the corresponding Rake finger according to the calculation result and the estimated amplitude of the corresponding Rake finger, wherein the corresponding Rake finger is the Rake finger for receiving radio signals transferred from the same propagation path in said plurality of 1D Rake receivers.

26. The mobile terminal according to claim 25, wherein said weight factor calculating unit calculates the input signals of said corresponding Rake finger with blind adaptive algorithm.
